(19) United States
(12) Patent Application Publication
(10) Pub. No.: US 2013/0341395 A1
(43) Pub. Date: Dec. 26, 2013

(54) METHOD AND SYSTEM FOR CHILLING AND DISPENSING BEVERAGE

(71) Applicant: Tony Yat-Tung Chan, Hong Kong (HK)

(72) Inventor: Tony Yat-Tung Chan, Hong Kong (HK)

(73) Assignee: SELFTAP PRO SYSTEMS LTD., Hong Kong (HK)

(21) Appl. No.: 13/530,135

(22) Filed: Jun. 22, 2012

(51) Int. Cl. B67D 1/12; F25D 31/00; F28F 1/10

(52) U.S. Cl. 235/381; 165/172; 62/452

(57) ABSTRACT

A beverage circuit for cooling a beverage when the beverage flows through inside the circuit, the circuit comprising a hollow tube allowing the beverage to enter into or exit from the circuit; wherein the tube being wounded to form a plurality of multi-layered coiled columns, all of which being arranged substantially in parallel to each other and stacked together column-by-column, each of the coiled columns comprising a plurality of layers; wherein the tube having a cross-sectional width not exceeding 6 mm; and wherein each of the coiled columns having a layer-width not exceeding 60 mm; thereby allowing an entirety of the coiled columns to occupy a compact space while providing a substantial amount of external surface area for the portion of the tube along the coiled columns to allow rapid cooling of the beverage.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to chilling and dispensing a beverage. In particular, this invention relates to a system for rapid chilling of the beverage and automatic, user-friendly dispensing of the same.

### BACKGROUND

A mobile dispenser of beverages offers an advantage over a fixed one in that the mobile beverage dispenser can be quickly installed and deployed in locations where people are eager to enjoy drinking beverages. These locations include, for example, open fields where parties are held. In addition to dispensing beverages, it is preferred that the mobile dispenser provides an additional function of cooling the beverages. Beverages such as beer and carbonated soft drinks typically provide more enjoyable drinking experience to drinkers when the beverages are cool or chilled rather than at the room temperature. Furthermore, it is advantageous if the mobile beverage dispenser can rapidly chill the beverages. This advantage is particularly valuable in case it is required to serve a lot of drinkers. In this case, even if a stock of chilled beverages is running out, the drinkers are not required to wait for a long time to get freshly chilled beverages.

A beverage chilling and dispensing system is used in the mobile dispenser for chilling beverages. Different constructions of beverage chilling units have been disclosed, for example, in EP0684434A2, EP0244031A1, U.S. Pat. No. 5,079,927 and U.S. Pat. No. 5,771,709. However, some constructions result in beverage chilling units that are large and bulky in order to achieve rapid chilling. Large, bulky beverage chilling units are not practically suitable for installation in mobile beverage dispensers. Small, compact beverage chilling units, on the other hand, usually have reduced cooling capabilities and they are difficult to achieve rapid chilling of beverages.

There is a need in the art for a beverage chilling and dispensing system that can rapidly chill beverages and that is compact for use in a mobile beverage dispenser.

### SUMMARY OF THE INVENTION

An aspect of the present invention is a beverage circuit for use in a beverage chilling and dispensing system. The beverage circuit is configured to cool a beverage when it flows through inside the beverage circuit. The beverage circuit comprises a hollow tube having an opening at each of two ends of the tube for allowing the beverage to enter into or exit from the circuit. In particular, the tube is wound to form a plurality of multi-layered coiled columns. These coiled columns are arranged substantially in parallel against each other and are stacked together column-by-column. Each of the coiled columns comprises a plurality of layers. In addition, the tube's cross-section has a width not exceeding 6 mm, and a layer of each of the coiled columns has a width not exceeding 60 mm. It follows that an entirety of the coiled columns is allowed to occupy a compact space while providing a substantial amount of external surface area for the portion of the tube along the coiled columns to thereby enable rapid cooling of the beverage.

Preferably, the width of the tube's cross-section is between 4 mm to 6 mm. It is also preferable that a layer of each of the coiled columns has a width between 50 mm to 60 mm. The portion of the tube running along the coiled columns is preferred to have a length not exceeding 60 m. Preferably, the entirety of the coiled columns is enclosable by a space defined as a rectangular cuboid of dimension 435 mm×370 mm×60 mm. The tube may be made of Grade 304 stainless steel.

A beverage chilling and dispensing system may comprise: the beverage circuit; a container for housing the beverage circuit; a pool of coolant for immersing at least the entirety of the coiled columns; a refrigerating circuit at least part of which is immersed in the pool of coolant to allow heat transfer between a beverage in the beverage circuit and a refrigerant agent in the refrigerating circuit, so that the beverage is chilled and the coolant is kept at a low temperature; and a refrigerator connecting to the refrigerating circuit, for cooling the refrigerant agent after circulating in the pool of coolant, and feeding the cooled refrigerant agent back to the refrigerating circuit for re-circulating in the pool of coolant. The system may further comprise a beverage-temperature maintaining member. The maintaining member is coupled to and positioned in proximity to a tap that releases the chilled beverage for user consumption. The maintaining member comprises a thermally-conductive tubular path through which the chilled beverage received from the beverage circuit is delivered to the tap. The tubular path is enclosed by a portion of the coolant obtained from the pool of coolant so that the chilled beverage is maintained at a low temperature before being released through the tap. A pump is used to pump the portion of the coolant from inside the container to the maintaining member. A coolant-return path is used to return the portion of the coolant back to the pool of coolant in the container.

Another aspect of the present invention is a beverage dispensing control and point-of-sale sub-system for use in the beverage chilling and dispensing system. In accordance with various embodiments, the beverage dispensing sub-system comprises a database; a central processor; a controller, a user interface means; a card and device reader; one or more flow meters; one or more latch or solenoid valves; and one or more temperature sensors.

The database is used to preserve data including, but is not limited to, the characteristics of the beverage to be dispensed, pricing scheme of the beverage, user account information, user payment information, and usage history.

The central processor is configured to retrieve from and save data to the database, receive input from and generate responses to the user through the user interface means, and by interacting with the controller, receive incoming data from the card and device reader for identifying and authenticating users and processing payment information, receive and process measurement data from the flow meter, and execute a control sequence controlling the valves. In accordance to one embodiment, the central processor is implemented by a tablet personal computer configured to interact with the controller, execute control sequence, and run a graphical user interface as the user interface means. In accordance to another embodiment, the tablet personal computer communicates via a local area network (LAN) with a backend personal computer, which interacts with the database and serves as an intermediary between the tablet personal computer and the database in retrieving data from and saving data to the database.

The user interface means provides the functionalities of displaying information and accepting user input. The information displayed includes, but is not limited to, beverage temperature, beverage selection, beverage quantity remaining in the beverage chilling and dispensing system, beverage quantity to be poured, pricing, user account information, user payment information, advertisements, newsfeed. The user interface means accepts user input for user account registration and update, beverage selection and dispensing commands, and payment information. The user interface means can be implemented partly or entirely with an electronic screen displaying a graphical user interface. The electronic screen can be a touch-sensitive screen for receiving user inputs. The graphical user interface can be personalized for different operators or owners of the beverage chilling and dispensing system.

The card and device reader is used to detect and read cards or devices with Radio-frequency Identification (RFID), Near Field Communication (NFC), or magnetic stripe technologies, encrypt and feed the data read to the central processor. Such cards or devices including, but are not limited to, credit cards, debit cards, bankcards, stored-value cards, and personal identification cards or badges.

The flow meter is used to measure the beverage flow in the beverage circuit and feed such measurement data to the central processor.

The latch or solenoid valves are installed in the beverage circuit and receive control signals from the controller for valve opening and shutting.

The one or more temperature sensors are used to measure the temperature of the beverage at various points in the beverage circuit and feed such measurement data to the central processor.

### BRIEF DESCRIPTION OF THE DRAWINGS

Embodiments of the invention are described in more detail hereinafter with reference to the drawings, in which

FIG. 1 depicts a beverage circuit, which is an exemplary embodiment of the present invention, for use in a beverage chilling and dispensing system;

FIG. 2 depicts a schematic diagram of an embodiment of a beverage chilling and dispensing system employing the beverage circuit disclosed in the present invention;

FIG. 3 depicts a schematic diagram of an embodiment of a beverage dispensing control and point-of-sale sub-system employed in a beverage chilling and dispensing system disclosed in the present invention;

FIG. 4 depicts a schematic diagram of an embodiment of a controller in a beverage dispensing control and point-of-sale sub-system employed in a beverage chilling and dispensing system disclosed in the present invention;

FIG. 5 depicts a flow diagram of an embodiment of a method of dispensing beverage in a beverage chilling and dispensing system disclosed in the present invention;

FIG. 6 depicts a flow diagram of another embodiment of a method of dispensing beverage in a beverage chilling and dispensing system disclosed in the present invention; and

FIG. 7 depicts a flow diagram of yet another embodiment of a method of dispensing beverage in a beverage chilling and dispensing system disclosed in the present invention; and

FIG. 8 depicts an exemplary embodiment of a graphical user interface of a beverage dispensing control and point-of-sale sub-system for use in the beverage chilling and dispensing system.

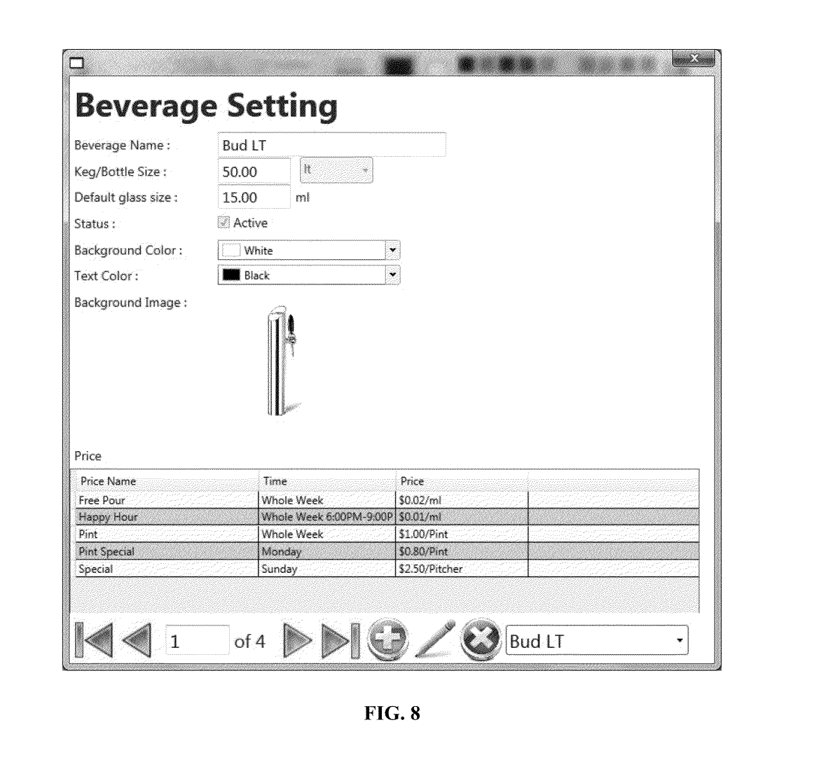

### DETAILED DESCRIPTION OF THE PREFERRED EMBODIMENTS

In the following description, methods and systems for beverage chilling and dispensing and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In a beverage chilling and dispensing system, a thermally conducting tube is usually used to make a beverage circuit inside which a beverage is allowed to flow through such that heat exchange between the beverage and the environment outside the beverage circuit enables the beverage to be chilled. Typically, the environment is a closed one and is defined by a thermally insulating container in which the beverage circuit is housed. The container is filled with a refrigerant agent in a liquid phase form, thereby allowing the beverage circuit to be immersed in the refrigerant agent. Heat exchange between the beverage and the refrigerant agent through an external surface of the beverage circuit results in cooling of the beverage as well as vaporization of part of the refrigerant agent into a gaseous phase. The beverage chilling and dispensing system further comprises a refrigerator. The gaseous refrigerant agent is collected and is directed to the refrigerator in which the gaseous refrigerant agent is cooled and condensed back to the liquid phase. The liquid-form refrigerant agent is then re-circulated back to the container for reuse in chilling the beverage.

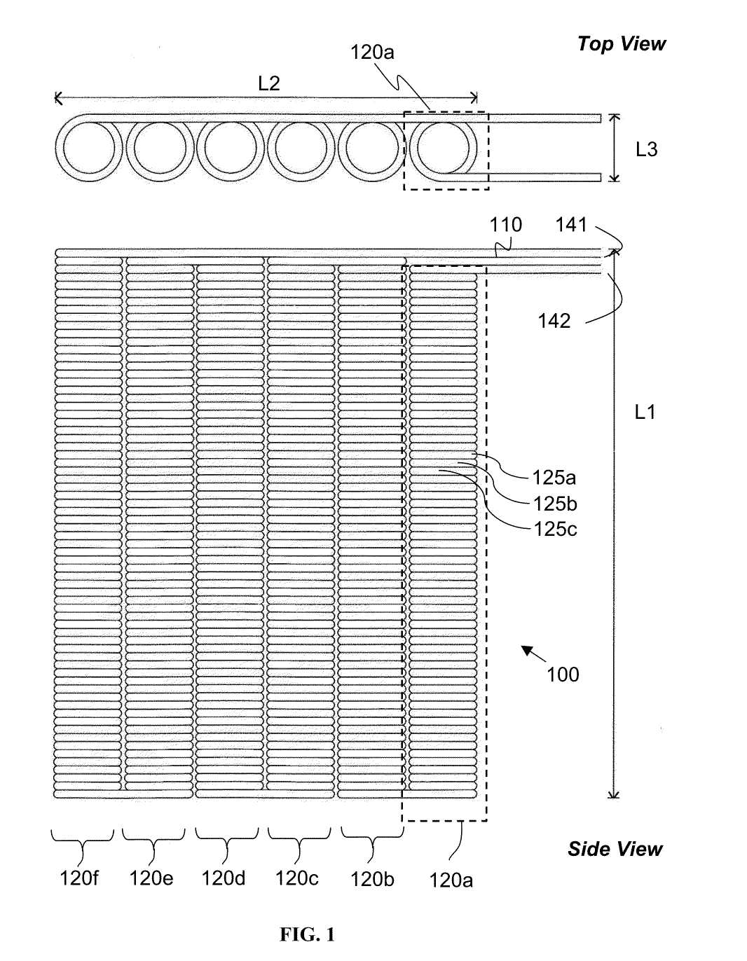

An aspect of the present invention is a beverage circuit for use in a beverage chilling and dispensing system. FIG. 1 depicts an exemplary embodiment of the beverage circuit disclosed in the present invention.

A beverage circuit 100 comprises a hollow tube 110 having two openings 141, 142 at both ends of the tube 110. The two openings 141, 142 allow a beverage to enter into or exit from the beverage circuit 100. The tube 110 is wound to form a plurality of multi-layered coiled columns 120. For the purpose of illustration, a coiled column 120a is highlighted in FIG. 1. Although FIG. 1 shows that there are six coiled columns 120a-120f for the purpose of illustration, the tube 110 disclosed in the present invention is not limited to only six coiled columns. Notice that the coiled columns 120 are connected as they are formed from the tube 110, allowing the beverage to flow through all the coiled columns 120. It also follows that one end of a coiled column is connected to an end of an adjacent coiled column.

All the coiled columns 120 are arranged substantially in parallel against each other and are stacked together column-by-column. For example, as shown in FIG. 1, the coiled column 120f is positioned substantially in parallel with its adjacent coiled column 120e, and the two coiled columns 120e, 120f are also stacked together one column by another column, leading to close proximity between these two coiled columns 120e, 120f. Thereby, an entirety of coiled columns 120 can be packed in a compact space. Although FIG. 1 shows that two adjacent coiled columns, e.g., the coiled columns 120e, 120f, do not column-wise touch each other, the present invention is not limited to this non-touching situation. However, it is preferable that two adjacent coiled columns do not column-wise touch each other. Since a portion of the beverage in one coiled column and another portion of the beverage in another coiled column may have different temperatures, a column-wise touching between two adjacent coiled columns may result in re-warming of the portion of beverage that is about to leave the beverage circuit 100 through one of the openings 141, 142.

Each of the multi-layered coiled columns 120 comprises a plurality of layers. To illustrate, FIG. 1 shows three consecutive layers 125a, 125b and 125c. Although these three layers 125a-c are substantially circular in shape, a layer disclosed in the present invention is not limited to this shape. A layer may be in any shape. Furthermore, two adjacent layers may be intimately packed together such that part of the external surface of one layer comes into physical contact with part of the external surface of another layer. Packing layers together intimately may not cause a big issue in re-warming the beverage as a temperature difference of beverage in two adjacent layers is small. It is also possible that two adjacent layers may not be intimately packed. All layers in a coiled column may or may not be substantially similar in size.

The inventors have experimentally determined dimensions of the tube 110 and of the coiled columns 120 for making the beverage circuit 100 compact while enabling rapid chilling of the beverage by providing adequate amount of external surface area of the tube 110 for heat exchange. Herein in the specification and in the appended claims, “width” of a two-dimensional figure with an arbitrary shape is defined as the smallest distance that can be formed between two opposite parallel lines tangent to the boundary of the figure. The inventors have identified that the beverage circuit 100 can be made compact when a cross-section of the tube 110 has a width not exceeding 6 mm and a layer of each of the coiled columns 120 has a width not exceeding 60 mm. Specifically, the cross-section of the tube 110 is the one derived from the external surface of the hollow tube 110 rather than from the inner surface thereof. As a layer of a coiled column is basically a three-dimensional object, herein in the specification and in the appended claims, “width of a layer of a coiled column” is referred to as a measurement of the width after projecting the layer onto a two-dimensional plane orthogonal to a major axis of this coiled column. For example, as it is shown in FIG. 1 that the layer 125a is substantially circular, a width of the layer 125a is a length L3.

For manufacturability of the coiled columns 120, it is preferable that the width of the cross-section of the tube 110 is between 4 mm to 6 mm, and that the width of a layer of each of the coiled columns 120 is between 50 mm to 60 mm. It is easily seen that if the tube 110 is longer, the external surface area of the tube 110 along the coiled columns 120 can be made larger, thereby enabling quicker chilling of the beverage. As experimentally determined by the inventors, preferably the portion of the tube 110 running along the coiled columns 120 has a length about but not exceeding 60 m for providing adequate amount of external surface of the tube 110 to thereby allow for rapid chilling of the beverage.

By using the above-determined dimensions of the tube 110 and of the coiled columns 120, the inventors have found that the entirety of the coiled columns 120 is enclosable by a space defined as a rectangular cuboid of dimension 435 mm×370 mm×60 mm. Taking the beverage circuit 100 as an example, one gets that: a length L1 is at most 370 mm; a length L2 is also at most 435 mm; and a length L3 has a length at most 60 mm.

To facilitate efficient heat exchange between the beverage inside the tube 100 and the environment outside the tube 100, preferably the tube 100 is made of a material having good thermal conduction properties. Furthermore, it is required that this material is resistant to corrosion and any chemical change resulted from contact with the beverage. One example of such material having good thermal conduction properties and the ability to resist corrosion is stainless steel. According to the above-determined dimensions of the tube 110, one may use a substantially circular tube made of stainless steel with a diameter of 6 mm for the tube 110. Optionally, one may select an inner diameter close to 6 mm, e.g., 5 mm, for this substantially circular tube in order to maintain a low enough flow speed of the beverage for effective cooling without the need to lower the flow rate of the beverage. In this regard, the stainless steel is required to have sufficient mechanical strength to support the substantially circular tube having a thickness of barely about 0.5 mm. Given that the stainless steel used is also required to be corrosion-resistant and thermally-conductive, the tube 110 may be made of Grade 304 stainless steel, whose specification is in accordance with ISO 3506. Also note that Grade 304 stainless steel is of a food-grade standard, and is suitable for carrying beverages.

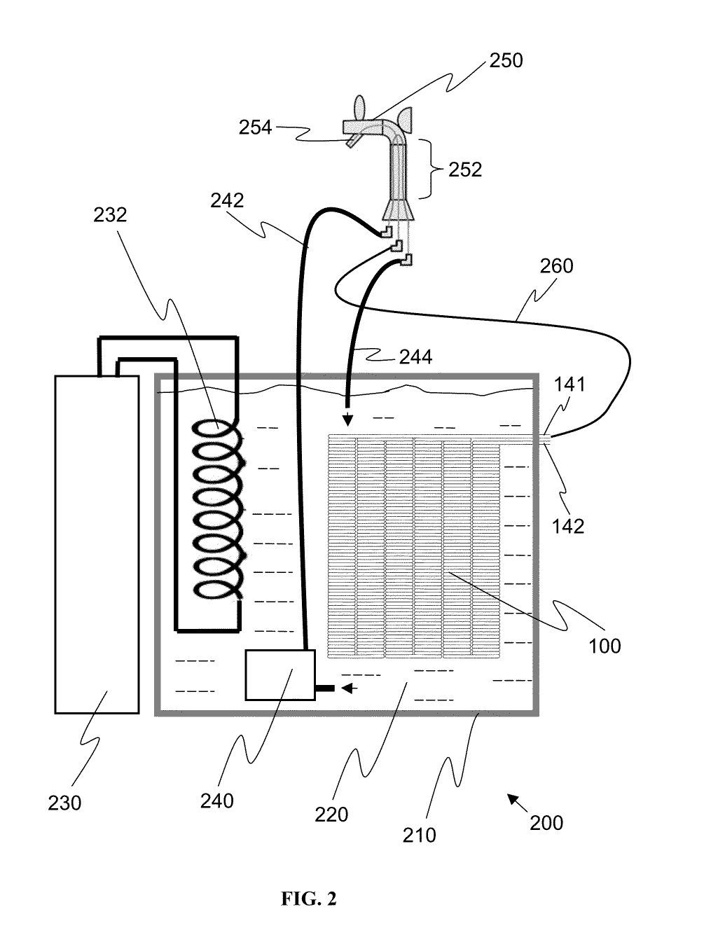

An embodiment of a beverage chilling and dispensing system employing the beverage circuit 100 is shown in FIG. 2. This system not only enables a beverage to be chilled but also maintains the beverage at a low temperature before release for user consumption.

A beverage chilling and dispensing system 200 comprises the beverage circuit 100 and a container 210, preferably thermally-insulating, for housing the beverage circuit 100. Inside the container 210 there is a pool of coolant 220, immersing at least the entirety of the coiled columns of the beverage circuit 100. Preferably the coolant has a high thermal capacity, and is low-cost, non-toxic and chemically friendly to at least the beverage circuit 100. An example of the coolant is water. The system 200 further comprises a refrigerating circuit 232. The refrigerating circuit 232 may be made of a thermally-conductive hollow tube, such that a refrigerant agent can flow through inside the refrigerating circuit 232. At least part of the refrigerating circuit 232 is immersed in the pool of coolant 220 so that heat is allowed to be transferred between the beverage and the refrigerant agent through the coolant when the beverage is inside the coiled columns of the beverage circuit 100 and is received through the opening 142 thereof. The beverage can then be chilled. In addition, the coolant in the pool of coolant 220 can be kept at a low temperature. For clarity in illustration, a space between the refrigerating circuit 232 and the beverage circuit 100 is drawn in FIG. 2. However, for efficient heat exchange, it is preferable that the refrigerating circuit 232 and the beverage circuit 100 are closely spaced. In addition, the refrigerating circuit 232 may substantially enclose the beverage circuit 100 for highly efficient heat transfer so as to speed up the chilling of the beverage. A refrigerator 230 is included and is connected to the refrigerating circuit 232. The refrigerator 230 receives the refrigerant agent after it is circulated in the pool of coolant 220. The received refrigerant agent, possibly at an elevated temperature due to heat exchange with the beverage, is cooled. Typically, the refrigerator 230 is realized as a compressor, and the refrigerant agent is cooled by compression. The cooled refrigerant agent is fed back to the refrigerating circuit 232 for re-circulating in the pool of coolant 220.

A beverage dispensing unit 250, outside the container 210, is used to dispense the beverage after chilling for user consumption, receiving the chilled beverage from the beverage circuit 100 through a beverage flow path 260 that connects to the opening 141. The beverage dispensing unit 250 comprises a tap 254 that releases the chilled beverage for user consumption, and a beverage-temperature maintaining member 252 that is coupled to and positioned in proximity to the tap 254. The beverage-temperature maintaining member 252 is used to keep the beverage at a low temperature before it is released through the tap 254, and to reduce a chance of possible re-warming after the beverage leaves the beverage circuit 100. The maintaining member 252 achieves these purposes with an availability of the coolant. A pump 240 is incorporated in the system 200 for pumping a part of the coolant from the pool of coolant 220 inside the container and supplying the part of the coolant to the maintaining member 252 through a coolant-supply path 242. The pump 240 may be installed inside or outside the container 210. The maintaining member 252 comprises a thermally-conductive tubular path through which the chilled beverage received from the beverage flow path 260 is delivered to the tap 254. In particular, the tubular path is enclosed by the part of the coolant supplied from the coolant-supply path 242. The chilled beverage can therefore be maintained at a low temperature before being released through the tap 254 by the presence of coolant enclosing the tubular path. A coolant-return path 244 is installed for returning the part of the coolant from the maintaining member 252 back to the pool of the coolant 220. An entirety of the coolant-supply path 242 and the coolant-return path 244 forms a coolant circulating circuit so that a temperature rise in the part of the coolant during maintaining the chilled beverage at a low temperature in the maintaining member 252 can be compensated for by a presence of this coolant circulating circuit.

Preferably, each of the coolant-supply path 242, the coolant-return path 244 and the beverage flow path 260 may be coated with a thermally isolating material for preventing or reducing a chance of undesirable re-warming of the coolant or the chilled beverage. Alternatively, it is possible that an entirety of the coolant-supply path 242, the coolant-return path 244 and the beverage flow path 260 may be bundled together and coated with a single thermally-isolating material.

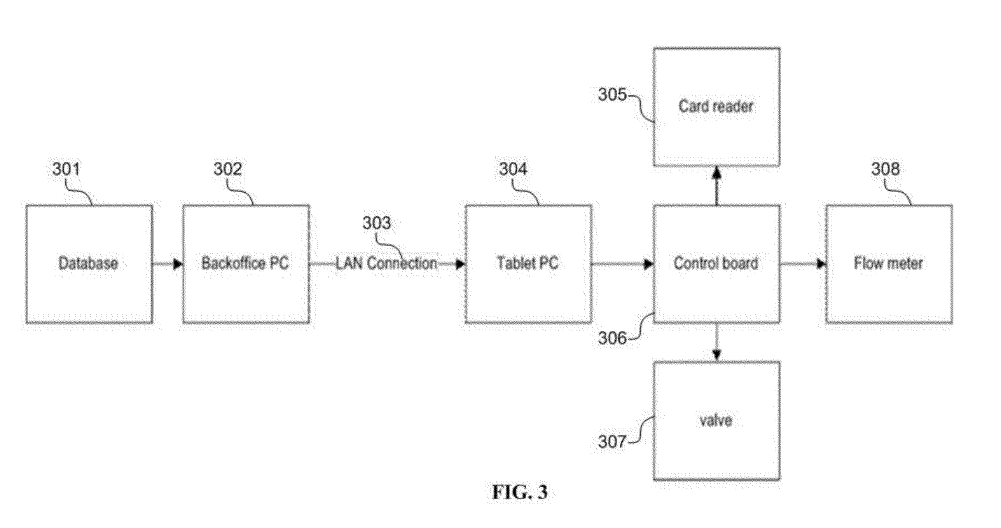

An embodiment of a beverage dispensing control and point-of-sale sub-system for use in the beverage chilling and dispensing system is shown in FIG. 3. In accordance with various embodiments, the beverage dispensing sub-system comprises a database 301; a central processor; a controller 306; a user interface means; a card and device reader 305; one or more flow meters 308; one or more latch or solenoid valves 307; and one or more temperature sensors.

The database 301 is used to preserve data including, but is not limited to, the characteristics of the beverage to be dispensed, pricing scheme of the beverage, user identification information, user payment information, and usage history.

The central processor is configured to retrieve from and save data to the database 301, receive input from and generate responses to the user through the user interface means, and by interacting with the controller 306, receive incoming data from the card and device reader 305 for identifying and authenticating users and processing payment information, receive and process measurement data from the flow meter 308, and execute a control sequence controlling the valves 307. In accordance to one embodiment, the central processor is implemented by a tablet personal computer 304 configured to interact with the controller 306, execute control sequence, and run a graphical user interface as the user interface means. In accordance to another embodiment, the tablet personal computer 304 communicates via a local area network (LAN) 303 with a backend personal computer 302, which interacts with the database 301 and serves as an intermediary between the tablet personal computer 304 and the database 301 in retrieving data from and saving data to the database 301.

The user interface means provides the functionalities of displaying information and accepting user inputs. The information displayed includes, but is not limited to, beverage temperature, beverage selection, beverage quantity poured, beverage quantity remained in the beverage chilling and dispensing system, beverage pricing, advertisements, newsfeeds, and user account information. The user interface means accepts user inputs for user account registration and update, beverage selection, beverage quantity to be poured, dispensing commands, and payment information. The user interface means can be implemented partly or entirely with an electronic screen displaying a graphical user interface. The electronic screen can be a touch-sensitive screen for receiving user inputs. The graphical user interface can be personalized for different operators or owners of the beverage chilling and dispensing system.

The card and device reader 305 is used to detect and read cards or devices with Radio-frequency Identification (RFID), Near Field Communication (NFC), or magnetic stripe technologies, encrypt, and feed the data read to the central processor. Such cards or devices including, but are not limited to, credit cards, debit cards, bankcards, stored-value cards, and personal identification cards or badges.

The one or more flow meters 308 are used to measure the beverage flow in the beverage circuit and feed such measurement data to the central processor.

The one or more latch or solenoid valves 307 are installed in the beverage circuit and receive control signals from the controller 306 for valve opening and shutting.

The one or more temperature sensors are used to measure the temperature of the beverage at various points in the beverage circuit and feed such measurement data to the central processor.

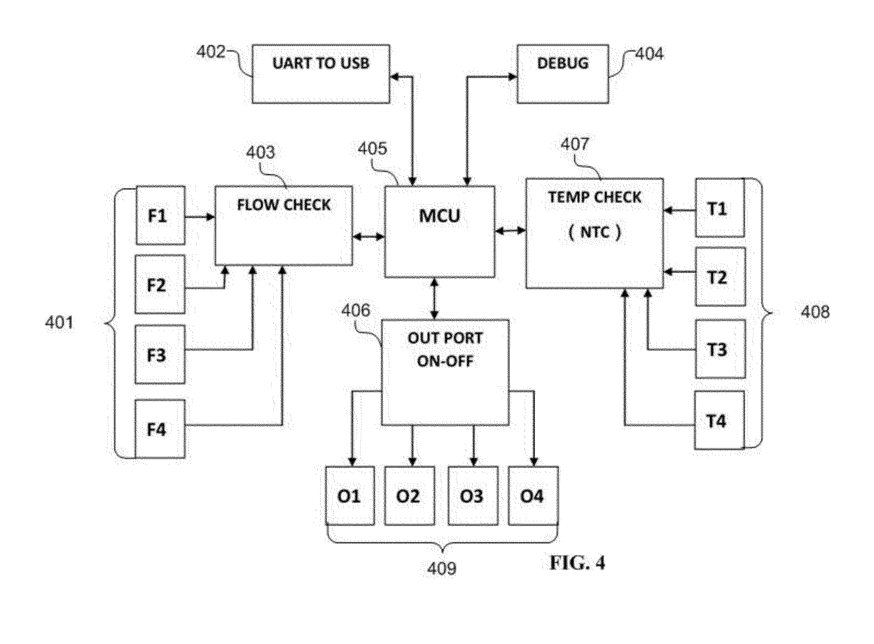

Referring to FIG. 4. In accordance to one embodiment, the controller is realized in an electronic circuit board comprising a microcontroller (MCU) 405; a universal asynchronous receiver/transmitter (UART) 402 to interface with a universal serial bus (USB) port connecting the central processor or the tablet personal computer; a debug port 404 for transmitting diagnostic data signal to and receiving command signal from an external diagnostic circuitry or device; a flow check port 403 for electrically connecting to and receiving beverage flow data signal from one or more flow meters 401; an output port 406 for electrically connecting to and sending control signal to one or more valves 409; and a temperature check port 407 for electrically connecting to and receiving beverage temperature data signal from one or more temperature sensors 408. By communicating with the central processor or the tablet personal computer through the UART 402, the MCU 405 receives control sequence data signal for beverage flow, in turn generates the valve opening/shutting control signal for each of the valves to the output port 406. The MCU 405 also sends the beverage flow data and beverage temperature to the central processor or the tablet personal computer through the UART 402.

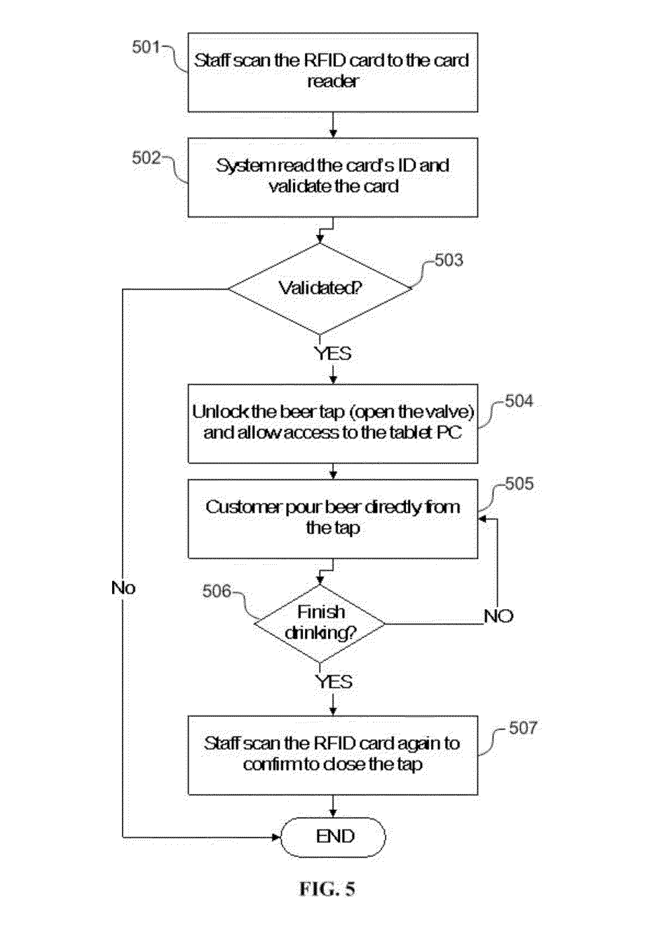

In accordance to one embodiment, process steps of a method for dispensing and executing point-of-sale of beverage in the beverage chilling and dispensing system is shown in FIG. 5. The method comprises: 501: a staff user scans his/her identification card or badge embedded with a RFID device, NFC device, or magnetic stripe at the card or device reader; 502: the card or device reader detects the staff user's identification card or badge and reads the identification data contained within its RFID device, NFC device, or magnetic stripe, the identification data is sent to the central processor (or the combination of the tablet personal computer and the backend personal computer) for validation against pre-recorded user account data in the database; if the identification data is invalid, the process terminates; otherwise 504: upon the positive validation of the staff user's identity, the user interface is unlocked allowing the staff user to enter the command to open, through the controller, one or more of the valves; 505: with the valves opened, beverage is allowed to be poured from the tap to a customer's glass; and 507: when the customer finishes drinking, the staff user scans his/her identification card or badge at the card or device reader, the user interface is locked and the central processor commands, through the controller, the valves to shut.

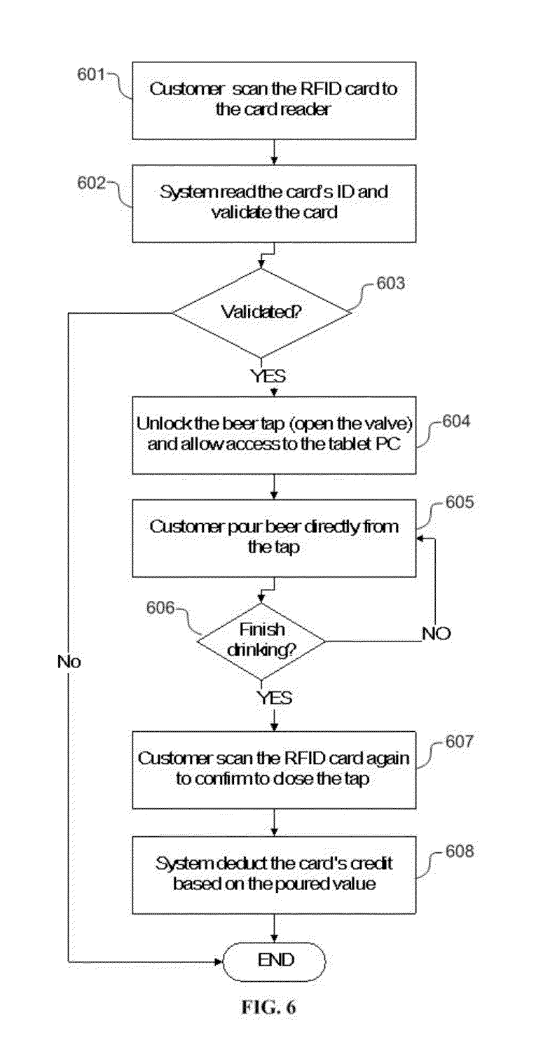

In accordance to another embodiment, process steps of a method for dispensing and executing point-of-sale of beverage in the beverage chilling and dispensing system is shown in FIG. 6. The method comprises: 601: a customer user scans his/her identification card or badge embedded with a RFID device, NFC device, or magnetic stripe at the card or device reader; 602: the card or device reader detects the customer user's identification card or badge and reads the identification data contained within its RFID device, NFC device, or magnetic stripe, the identification data is sent to the central processor (or the combination of the tablet personal computer and the backend personal computer) for validation against saved user account data in the database; if the identification data is invalid, the process terminates; otherwise 604: upon the positive validation of the customer user's identity, the user interface is unlocked allowing the customer user access to enter the command to open, through the controller, one or more of the valves; 605: with the valves opened, beverage is allowed to be poured from the tap to a customer's glass while the central processor records the poured amount from the flow measurement data collected from the flow meters; 607: when the customer finishes drinking, the customer user scans his/her identification card or badge at the card or device reader, the user interface is locked and the central processor commands, through the controller, the valves to shut; and 608: the central processor executes a payment process comprising deducting a money value for the total amount of beverage poured from a pre-defined payment account associated with the customer user.

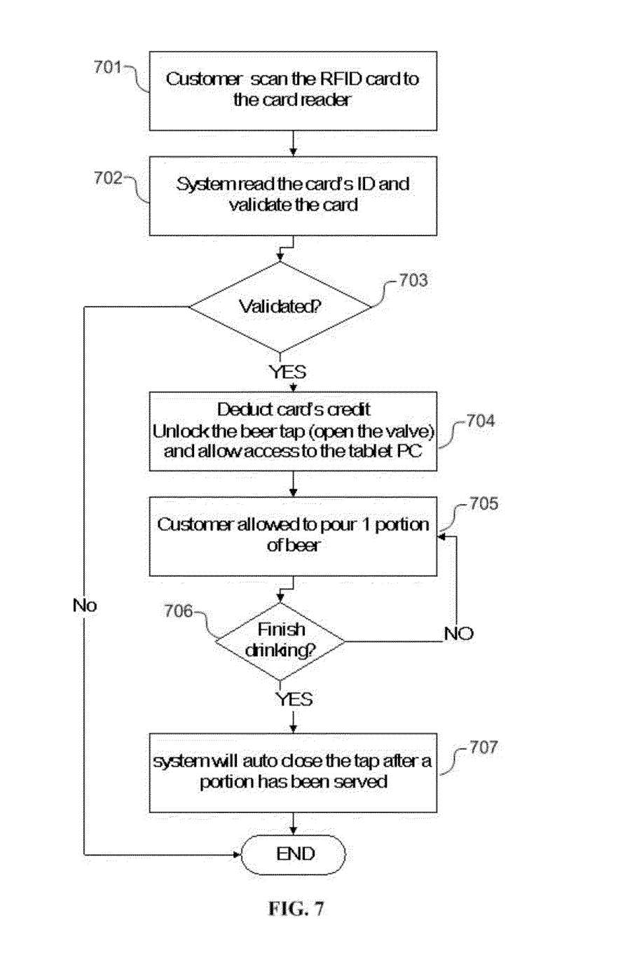

In accordance to yet another embodiment, process steps of a method for dispensing and executing point-of-sale of beverage in the beverage chilling and dispensing system is shown in FIG. 7. The method comprises: 701: a customer user scans his/her identification card or badge embedded with a RFID device, NFC device, or magnetic stripe at the card or device reader; 702: the card or device reader detects the customer user's identification card or badge and reads the identification data contained within its RFID device, NFC device, or magnetic stripe, the identification data is sent to the central processor (or the combination of the tablet personal computer and the backend personal computer) for validation against saved user account data in the database; if the identification data is invalid, the process terminates; otherwise 704: upon the positive validation of the customer user's identity, the user interface is unlocked allowing the customer user to specify the portion of beverage to be poured, execute a payment process comprising deducting a money value for the portion of beverage to be poured from a pre-defined payment account associated with the customer user, and enter the command to open, through the controller, one or more of the valves; 705: with the valves opened, beverage is allowed to be poured from the tap to a customer's glass while the central processor records the poured amount from the flow measurement data collected from the flow meters; 707: after the portion of beverage has been poured, the user interface is automatically locked and the central processor commands, through the controller, the valves to shut.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A beverage circuit for cooling a beverage when the beverage flows through inside the circuit, the circuit comprising a hollow tube having an opening at each of two ends of the tube allowing the beverage to enter into or exit from the circuit;
wherein the tube being wounded to form a plurality of multi-layered coiled columns, all of which being arranged substantially in parallel to each other and stacked together column-by-column, each of the coiled columns comprising a plurality of layers;
wherein the tube having a cross-sectional width not exceeding 6 mm; and
wherein each of the coiled columns having a layer-width not exceeding 60 mm;
thereby allowing an entirety of the coiled columns to occupy a compact space while providing a substantial amount of external surface area for the portion of the tube along the coiled columns to allow rapid cooling of the beverage.

2. The beverage circuit of claim 1, wherein the cross-sectional width of the tube being between 4 mm to 6 mm.

3. The beverage circuit of claim 1, wherein the layer-width of each of the coiled columns being between 50 mm to 60 mm.

4. The beverage circuit of claim 1, wherein the portion of the tube running along the coiled columns having a length not exceeding 60 m.

5. The beverage circuit of claim 1, wherein the entirety of the coiled columns being enclosable by a space defined as a rectangular cuboid of dimension.

6. The beverage circuit of claim 1, wherein the tube is made of Grade 304 stainless steel.

7. A beverage chilling and dispensing system for chilling a beverage, comprising:
the beverage circuit of claim 1;
a container for housing the beverage circuit;
a pool of coolant inside the container for immersing at least the entirety of the coiled columns;
a refrigerating circuit having a refrigerant agent therein, at least part of the refrigerating circuit being immersed in the pool of coolant to allow heat transfer between the beverage and the refrigerant agent through the coolant when the beverage is inside the coiled columns, thereby chilling the beverage and keeping the coolant at a low temperature;
a refrigerator connecting to the refrigerating circuit, for cooling the refrigerant agent after circulating in the pool of coolant, and feeding the cooled refrigerant agent back to the refrigerating circuit for re-circulating in the pool of coolant;
a pump for pumping a part of the coolant from inside the container to outside the container;
a beverage-temperature maintaining member outside the container, coupled to and positioned in proximity to a tap that releases the chilled beverage for user consumption, and receiving the part of the coolant from the pump, the maintaining member comprising a thermally-conductive tubular path through which the chilled beverage received from the beverage circuit is delivered to the tap, wherein the tubular path is enclosed by the part of the coolant to thereby maintain the chilled beverage at a low temperature before being released through the tap; and
a coolant-return path for returning the part of the coolant from the maintaining member back to the pool of coolant in the container, thereby forming a coolant circulating circuit to compensate for a temperature rise in the part of the coolant during maintaining the chilled beverage at a low temperature in the maintaining member.

8. The beverage chilling and dispensing system of claim 7, further comprising a beverage dispensing control and point-of-sale sub-system comprising:
a database configured to preserve data including characteristics of the beverage to be dispensed, pricing scheme of the beverage, user identification information, and user payment information.
a central processor configured to retrieve from and save data to the database, receive input from and generate responses to a user through a user interface means, and by interacting with a controller, receive incoming data from a card and device reader for identifying and authenticating the user and processing payment information, receive and process measurement data from one or more flow meters, and execute a control sequence controlling one or more valves.
the controller;
the user interface means configured to display information and accept user inputs;
the card and device reader configured to detect and read cards or devices and feed the data read to the central processor;
one or more flow meters configured to measure beverage flow in the beverage circuit and feed measurement data to the central processor.
one or more latch or solenoid valve installed in the beverage circuit and configured to receive control signals from the controller for valve opening and shutting; and
one or more temperature sensors configured to measure temperature of the beverage at various points in the beverage circuit and feed measurement data to the central processor

9. The beverage chilling and dispensing system of claim 8, wherein the central processor being implemented by a tablet personal computer and a backend personal computer; wherein tablet personal computer being configured to interact with the controller, execute control sequence, and run a graphical user interface as the user interface means; and the backend personal computer being configured to interact with the database and serve as an intermediary between the tablet personal computer and the database in retrieving data from and saving data to the database.

10. The beverage chilling and dispensing system of claim 8, wherein the card and device reader being configured to detect and read cards or devices equipped with Radio-frequency Identification (RFID), Near Field Communication (NFC), or magnetic stripe technologies; and wherein the cards or devices including credit cards, debit cards, bankcards, stored-value cards, and personal identification cards or badges.

11. The beverage chilling and dispensing system of claim 8, wherein the information displayed by the user interface means includes beverage temperature, beverage selection, beverage quantity poured, beverage quantity remained in the beverage chilling and dispensing system, beverage pricing, advertisements, newsfeeds, and user account information.

12. The beverage chilling and dispensing system of claim 8, wherein the beverage dispensing control and point-of-sale sub-system being configured to execute a process comprising:
the card or device reader detecting a staff user's identification card or badge and reading an identification data contained in the identification card or badge for a first time;
the central processor validating the identification data against pre-recorded user account data in the database;
upon positive validation of the identification data, the user interface means being unlocked allowing the staff user to enter a command to open the valves, thereby allowing the beverage to be poured from the beverage circuit to a beverage container for serving;
the card or device reader detecting the staff user's identification card or badge and reading the identification data contained in the identification card or badge for a second time;
the central processor validating the identification data against pre-recorded user account data in the database; and
upon positive validation of the identification data, the user interface being locked and the central processor, through the controller, sending a control signal for shutting the valves.

13. The beverage chilling and dispensing system of claim 8, wherein the beverage dispensing control and point-of-sale sub-system being configured to execute a process comprising:
the card or device reader detecting a customer user's identification card or badge and reading an identification data contained in the identification card or badge for a first time;
the central processor validating the identification data against pre-recorded user account data in the database;
upon positive validation of the identification data, the user interface means being unlocked allowing the customer user to enter a command to open the valves, thereby allowing the beverage to be poured from the beverage circuit to a beverage container for serving;
the card or device reader detecting the customer user's identification card or badge and reading the identification data contained in the identification card or badge for a second time;
the central processor validating the identification data against pre-recorded user account data in the database;
upon positive validation of the identification data, the user interface being locked and the central processor, through the controller, sending a control signal for shutting the valves; and
the central processor executes a payment process comprising deducting a money value for a total amount of the beverage poured from a pre-defined payment account associated with the customer user.

14. The beverage chilling and dispensing system of claim 8, wherein the beverage dispensing control and point-of-sale sub-system being configured to execute a process comprising:
the card or device reader detecting a customer user's identification card or badge and reading an identification data contained in the identification card or badge;
the central processor validating the identification data against pre-recorded user account data in the database;
upon positive validation of the identification data, the user interface means being unlocked allowing the customer user to specify a portion of the beverage to be poured, executes a payment process comprising deducting a money value for the portion of the beverage to be poured from a pre-defined payment account associated with the customer user, and to enter a command to open the valves, thereby allowing the beverage to be poured from the beverage circuit to a beverage container for serving; and
after the portion of the beverage is poured, the user interface being locked and the central processor, through the controller, sending a control signal for shutting the valves.
